(19) United States
(12) Patent Application Publication
(10) Pub. No.: US 2013/0327293 A1
(43) Pub. Date: Dec. 12, 2013

(54) METHOD OF OPERATING AN INTERNAL COMBUSTION ENGINE WITH LOW NOx COMBUSTION

(71) Applicant: DAIMLER AG, (US)

(72) Inventors: Torsten DIELER, Stuttgart (DE); Ruediger HERWEG, Esslingen (DE); Dirk HAASE, Leutenbach (DE)

(73) Assignee: DAIMLER AG, Stuttgart (DE)

(21) Appl. No.: 13/858,014

(22) Filed: Apr. 6, 2013

Related U.S. Application Data
(63) Continuation-in-part of application No. PCT/EP2011/005000, filed on Oct. 7, 2011.

(30) Foreign Application Priority Data
Oct. 7, 2010 (DE) 10 2010 047 797.4
Mar. 31, 2011 (DE) 10 2011 015 627.5

(51) Int. Cl. F02P 9/00

(52) U.S. Cl. CPC F02P 9/00
USPC 123/406.12

(57) ABSTRACT

An operating mode for an internal combustion engine, in particular a directly injected internal combustion engine featuring a plurality of combustion chambers, in particular for a direct-injection gasoline engine, for example in a motor vehicle, an operating mode having at least in part low-NOx combustion (NAV) and having a plurality of partial operating modes whereby it is switched between a RZV partial operating mode having pure controlled auto-ignition (RZV) and a NAV partial operating mode, whereby in the case of said NAV partial operating mode, at an ignition point (ZZP) a largely homogeneous, lean fuel/exhaust gas/air mixture in the respective combustion chamber having a combustion air ratio of λ≧1 is spark ignited by means of an ignition device, where the flame front combustion (FFV) initiated by the spark-ignition transitions to a controlled auto-ignition (RZV). By combining the NAV partial operating mode with the RZV partial operating mode, the engine load range in which a controlled auto-ignition (RZV) can be performed enlarged, and as a result the fuel consumption and the NOx emissions is reduced in this expanded engine load range too.

### CROSS-REFERENCE TO RELATED APPLICATION

This is a continuation-in-part application of pending international application PCT/EP2011/005000 filed Oct. 7, 2011 and claiming the priority of German Application No. 10 2010 047 797.4 filed Oct. 7, 2010 and the priority of German Application No. 10 2011 015 627.5 filed Mar. 31, 2011.

The present invention describes an operating mode for an internal combustion engine, in particular for a reciprocating piston engine, for example, for a gasoline engine with direct injection in a motor vehicle, having low-NOx combustion (NAV).

Downsizing can be used in the automotive engineering sector, addition to other measures, in order to reduce CO₂ emissions. In this context, downsizing means constructing, employing and operating small-displacement engines in such a way that they achieve equivalent or better rankings with respect to driving behaviour when compared to their predecessor large-displacement engines. Downsizing allows fuel consumption to be reduced and thus CO₂ emissions to be lowered. In addition, engines with smaller displacements have lower absolute frictional losses.

Smaller displacement engines are, however, characterised by having lower torque, especially at low speeds, leading to the vehicle having a poorer dynamic response and thus reduced flexibility. Disadvantages associated with the downsizing of gasoline engines can be largely compensated for through appropriate operating modes.

An operating mode is known from EP 1 543 228 81 wherein, for example, a lean fuel/exhaust gas/air mixture in the combustion chamber of the internal combustion engine is caused to auto-ignite. In order that compression ignition occurs at the desired time, fuel is introduced into the lean, homogeneous fuel/exhaust gas/air mixture in the combustion chamber at the appropriate compression shortly before being spark ignited, so that a richer fuel-air mixture is formed. Embedded in the lean, homogeneous fuel/exhaust gas/air mixture, this concentrated fuel-air mixture serves as the initiator for compression-ignited combustion in the combustion chamber.

DE 10 2006 041 467 A1 contains a description for an operating mode for a gasoline engine having homogeneous compression-ignited combustion. If the homogeneous fuel/exhaust gas/air mixture, said mixture being a lean mixture, is compressed, in contrast to the gasoline engine operating mode, combustion does not spread in the combustion chamber as a flame front originating from the point of ignition, but instead at an appropriate compression level the homogeneous fuel/exhaust gas/air mixture ignites at several points in the respective combustion chamber almost simultaneously, so that in this case controlled auto-ignition sets in. Controlled auto-ignition (RZV) exhibits significantly lower nitrogen oxide emissions along with high efficiency in terms of fuel consumption compared to the spark-ignited otto-cycle operation mode. This low-emission, efficient RZV operating mode with controlled auto-ignition can, however, only be used at a lower and possibly medium engine load/engine speed range, as knocking tendency increases with decreasing charge dilution, and thus the useful application of the RZV operating mode in higher engine load ranges is limited.

The present invention is concerned with the problem of specifying an improved, or at least an alternative operating mode for an, in particular directly injected, internal combustion engine, which is characterised in particular by reliable operating stability, inter alia in a higher engine load range with simultaneous low-NOx combustion.

### SUMMARY OF THE INVENTION

According to the invention, this problem is solved by the subject-matter of the independent claim. Advantageous embodiments are the subject matter of the dependent claims.

The invention is based on the general idea, as part of an operating mode for an internal combustion engine, in particular a directly injected internal combustion engine featuring a plurality of combustion chambers, in particular for a direct-injection gasoline engine, for example in a motor vehicle, said operating mode having at least in part low-NOx combustion (NAV) and having a plurality of partial operating modes, to switch between a RZV partial operating mode with pure controlled auto-ignition (RZV) and a NAV partial operating mode, whereby during said NAV partial operating mode at an ignition point (ZZP), a largely homogeneous, lean fuel/exhaust gas/air mixture in the respective combustion chamber having a combustion air ratio of λ≧1 is spark ignited by means of an ignition device where the flame front combustion (FFV) initiated by the spark-ignition transitions to a controlled auto-ignition (RZV).

In an advantageous embodiment, the NAV partial operating mode makes possible the implementation of a controlled auto-ignition (RZV), including at engine load or engine speed ranges where a pure RZV partial operating mode is only conditionally possible due to its low operational stability. Due to the expansion of the region of the engine characteristics map in which a controlled auto-ignition can be performed, a low-NOx combustion is possible through a larger operating range of the internal combustion engine with simultaneous high efficiency with regard to fuel consumption.

A directly injected internal combustion engine having a plurality of combustion chambers can be operated according to different operating modes or different partial operating modes. Hence there are a number of otto-cycle partial operating modes possible. The stoichiometric otto-cycle partial operating mode has a combustion air ratio or air/fuel ratio λ=1 and is spark ignited by an ignition device, whereby flame front combustion (FFV) sets in. The stoichiometric otto-cycle partial operating mode can be applied throughout the entire engine load and/or engine speed range. It is preferentially implemented over other partial operating modes in the high engine load or engine speed range.

A otto-cycle partial operating mode can be spark ignited even with excess air, and can thus be implemented with a combustion air ratio λ>1. This partial operating mode is also commonly referred to as the DES partial operating mode (Stratified Direct Injection), wherein a stratified, overall lean fuel/exhaust gas/air mixture is formed in the respective combustion chamber by multiple direct fuel injections. Due to its stratified composition, at least in an idealised system, each combustion chamber has two regions having different combustion air ratios λ. This stratification is typically generated through multiple fuel injections. First, a lean, homogeneous fuel/exhaust gas/air mixture may be introduced into the respective combustion chamber by one or more injections of fuel. Into this lean, homogeneous region, a fuel/air mixture that is richer than that in the lean, homogeneous region, is then positioned in the area of the ignition device through a final injection of fuel that can also take the form of multiple injections. This method is commonly referred to as HOS (Homogenous Stratified Mode). The overall lean fuel/exhaust gas/air mixture in the combustion chamber can be ignited and reacted through flame front combustion (FFV) by the richer fuel/air mixture in the area of the ignition device. The DES and HOS partial operating modes are preferred in the lower engine load and/or engine speed range.

The DES and HOS partial operating modes can also be compression ignited, but are then usually no longer referred to as DES or HOS partial operating modes.

At lower engine load and/or engine speed ranges, the RZV partial operating mode can likewise be implemented, wherein a lean, homogeneous fuel/exhaust gas/air mixture in the respective combustion chamber is triggered by controlled auto-ignition and thus compression ignited. In contrast with an otto-cycle partial operating mode, wherein a flame front combustion (FFV) arises through spark ignition, with the RZV partial operating mode, the fuel/exhaust gas/air mixture in the respective combustion chamber ignites in multiple regions of the respective combustion chamber almost simultaneously so that controlled auto-ignition occurs. The RZV partial operating mode exhibits significantly lower NOx emissions compared to the otto-cycle partial operating mode, while at the same time being characterised by lower fuel consumption.

The NAV partial operating mode, which is the subject matter of the invention, can be thought of as being a combination of a spark-ignited, otto-cycle partial operating mode and an RZV partial operating mode. Thus, for the NAV partial operating mode there is a homogeneous, lean fuel/exhaust gas/air mixture that is spark ignited by means of an ignition device. With the NAV partial operating mode, following an initial flame front combustion (FFV), the combustion of the homogeneous fuel/exhaust gas/air mixture transitions to a controlled auto-ignition (RZV). As a result, the NAV partial operating mode exhibits lower fuel consumption and reduced NOₓ emissions when compared to the otto-cycle partial operating mode due to the controlled auto-ignition (RZV).

In contrast with the RZV partial operating mode, during the NAV partial operating mode combustion is spark ignited by an ignition device. For this reason, amongst others, operating stability of the mixture ignition and/or combustion is significantly improved, especially in the higher end of the engine load or engine speed range. Thus the homogeneous, lean fuel/exhaust gas/air mixture starts to combust with a kind of a otto-cycle flame front combustion (FFV) that then transitions into a controlled auto-ignition (RZV). In this way the NAV partial operating mode combines the advantages of controlled auto-ignition (RZV) with the spark-ignited, operationally stable ignition of the fuel/exhaust gas/air mixture. This NAV partial operating mode, which is the subject matter of the invention, can be realised by supplying an appropriate fuel/exhaust gas/air mixture to each combustion chamber, as well as by spark igniting at the correct time by means of an ignition device.

The NAV partial operating mode is characterised by a low pressure gradient and a reduced knocking tendency. As a result of this, the NAV partial operating mode makes controlled auto-ignition (RZV) feasible in a higher engine load range in which the pure RZV partial operating mode is no longer operationally stable enough due to the increasing pressure gradient and irregular combustion conditions, and in particular, because of the increased knocking tendency.

A comparison of the partial operating modes leads to the following conclusion:

| Partial | Fuel | NOₓ | | Engine |
|---|---|---|---|---|
| operating modes | consumption | emissions | Application | smoothness |
| otto-cycle | +/− | +/− | +++ | +/− |
| λ = 1 | | | | |
| DES | +++ | −− | + | +/− |
| RZV | ++ | +++ | + | +/− |
| NAV | ++ | ++ | ++ | ++ |

(− \hat{=} deterioration, + \hat{=} improvement ++ \hat{=} much improvement, +++ \hat{=} very much improvement)

As a result, partial operating modes with controlled auto-ignition (RZV) exhibit both lower fuel consumption and reduced NOx emission values when compared with stoichiometric otto-cycle combustion systems. Moreover, through the NAV partial operating mode, the operating range can be extended to include the efficient controlled auto-ignition mode. With the NAV combustion method, engine smoothness is also improved when compared to the partial operating modes with compression ignition.

A lean fuel/exhaust gas/air mixture is a fuel/exhaust gas/air mixture that has a combustion air ratio of λ>1 and thus an excess of air, whereas a rich fuel/exhaust gas/air mixture has a combustion air ratio of λ<1. A stoichiometric ratio is λ=1.

he combustion air ratio is a dimensionless physical quantity that is used to describe the composition of a fuel/exhaust gas/air mixture. The combustion air ratio λ is calculated as a quotient of the actual air mass available for combustion and the minimum stoichiometric air mass required for a complete combustion of the available fuel. Accordingly, if λ=1, one talks of a stoichiometric combustion air ratio or fuel/exhaust gas/air mixture, and when λ>1 of a lean air combustion ratio or fuel/exhaust gas/air mixture. Furthermore, if λ=1 or λ<1, one talks of a rich combustion air ratio or fuel/exhaust gas/air mixture.

In a preferred embodiment, there is for the NAV partial operating mode a combustion air ratio at the ignition point between 1 and 2.

Furthermore, the composition of the fuel/exhaust gas/air mixture can be specified by the charge dilution. Regardless of whether there is a lean, rich or stoichiometric fuel/exhaust gas/air mixture, the charge dilution dictates how much fuel in relation to the other components of the fuel/exhaust gas/air mixture was introduced into the combustion chamber. The charge dilution is the ratio of the mass of fuel to the total mass of the fuel/exhaust gas/air mixture that is present in the respective combustion chamber.

In a preferred embodiment of the NAV partial operating mode, the charge dilution is set to between 0.03 and 0.05.

Because ignition timing plays a crucial role in the NAV partial operating mode, in a preferred embodiment the ignition point is set to occur at a crank angle (CA) of between −45° and −10°.

The crank angle (CA) is the position in degrees of the crankshaft in relation to the movement of the piston in the cylinder or combustion chamber. In the case of a four-stroke cycle, where an intake stroke is followed by a compression stroke, then an expansion stroke and subsequently an exhaust stroke, the top dead centre (TDC) position of the retracted piston in the respective combustion chamber or cylinder between the compression stroke and the expansion stroke is usually assigned a crank angle (CA) of 0°. Starting from this top dead centre position at 1° CA, the crank angle increases towards the expansion stroke and exhaust stroke and decreases towards the compression stroke and intake stroke. Using the described gradation system, the intake stroke occurs between −360° CA and −180° CA, the compression stroke between −180° CA and 0° CA, the expansion stroke between 0° CA and 180° CA and the exhaust stroke between 180° CA and 360° CA.

When a largely homogeneous, lean fuel/exhaust gas/air mixture is referred to, this is understood to be a homogeneous, lean fuel/exhaust gas/air mixture that is essentially uniformly distributed in the respective combustion chamber. In an ideal situation there is a completely homogeneous distribution. In a realistic scenario, however, small inhomogeneities can be present, but they have no significant impact on the respective partial operating mode. This type of homogenous, lean fuel/exhaust gas/air mixture can be produced by single or multi-point fuel injection. In a preferred embodiment the injections or multi-point injections of fuel are performed dependent on load and/or engine speed.

In a preferred embodiment, the NAV partial operating mode is implemented at an engine speed of between 5% and 70% of the internal combustion engine's maximum speed.

In a likewise preferred embodiment, the NAV partial operating mode is implemented at an engine load of between 10% and 70 of the internal combustion engine's maximum load.

In addition, an internal exhaust gas recirculation can be effected as part of the NAV partial operating mode in order to preheat the fuel/exhaust gas/air mixture in the respective combustion chamber. This exhaust gas recirculation can be implemented as exhaust gas re-induction or exhaust gas retention. With exhaust gas re-induction, exhaust gas is fed into the respective combustion chamber through expulsion of the exhaust gas into the air intake and/or into the exhaust section with subsequent re-induction. As an alternative to, or in addition to exhaust gas re-induction, internal exhaust gas recirculation through the retention of exhaust gas can be implemented, wherein a portion of the exhaust gas is retained in the respective combustion chamber. In order to cool the fuel/exhaust gas/air mixture, external exhaust gas recirculation can be performed whereby the externally recirculated exhaust gas can be additionally cooled.

The NAV partial operating mode can be implemented in combination with, and/or in addition to a spark ignited, stratified DES partial operating mode.

In this case a preferred embodiment allows the ignition point (ZZP) and/or centre of the combustion to be set at a crank angle that corresponds to the crank angle at the ignition point (ZZP) and/or the combustion centre of a spark ignited, stratified DES partial operating mode.

In this case a preferred embodiment involves the NAV partial operating mode being implemented at an engine speed range and/or engine load range at which a spark ignited, stratified DES partial operating mode is also possible.

In a particularly preferred embodiment, the NAV partial operating operating mode with purely controlled auto-ignition (RZV), whereby the two mode is implemented in combination with and/or in addition to an RZV partial partial operating modes are switched between if the other partial operating mode exhibits a lower operating stability.

Further important features and advantages of the invention arise from the dependent claims, from the diagrams and from the descriptions based on the diagrams.

It is understood that the features that are mentioned above and those still to be described in the following can be used not only in the combination specified in each case, but also in other combinations or individually, without exceeding the scope of the present invention.

Preferred exemplary embodiments of the invention are illustrated in the figures and explained in more detail in the description below, whereby the same reference numerals refer to the same or similar or functionally identical components.

### BRIEF DESCRIPTION OF THE DRAWINGS

Depicted schematically in each case are:

FIG. 1: a graphical representation of a combustion curve of the NAV operating mode,

FIG. 2: a comparison of valve lift heights of an RZV, NAV, and DES operating mode,

FIG. 3: a graphical representation of an engine characteristics map of the RZV and NAV operating modes,

FIG. 4: setting conditions of the RZV and NAV operating mode,

FIG. 5: an operating strategy for an internal combustion engine operated having at least one RZV partial operating mode and having a NAV partial operating mode.

### DETAILED DESCRIPTION OF THE PARTICULAR EMBODIMENTS

FIG. 1 shows a combustion curve diagram 1 of a NAV partial operating mode, where the crank angle CA is plotted along the X-axis 2 in degrees while a combustion curve BV is plotted up the Y-axis 3 in Joules. The combustion process of the NAV partial operating mode is represented by a curve 4. A fuel/exhaust gas/air mixture introduced into the respective combustion chamber is spark ignited at an ignition point 5 and at a crank angle of −30°+/−5° CA. Up to a boundary line 6 the fuel/exhaust gas/air mixture introduced into the respective combustion chamber burns with a olio-cycle flame front combustion (FFV). After the boundary line 6, the fuel/exhaust gas/air mixture, which has become further heated and subjected to increased pressure by the flame front combustion (FFV), begins to transition to a controlled auto-ignition (RZV). A sufficiently high pressure and temperature required for compression ignition are built up by the advancing flame front combustion (FFV). In this way the NAV partial operating mode can be divided into a phase I having homogeneous flame front combustion (FFV) and a phase II having controlled auto-ignition (RZV), whereby both phases I, II are separated by the boundary line 6.

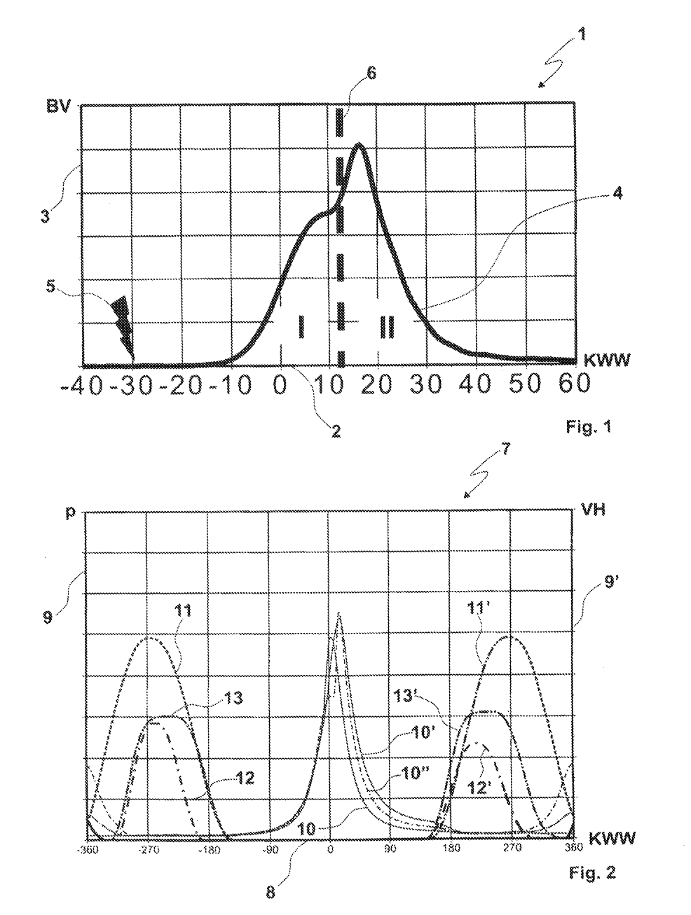

FIG. 2 shows a cylinder pressure/valve lift diagram 7, where the crank angle CA is plotted along the X-axis 8 in degrees while the cylinder pressure P in bar (left) and the valve lift VH in millimetres (right) is plotted up the Y-axis 9,9′. The curves 10, 10′, 10″ reference the cylinder pressure curves of the DES, RZV and NAV partial operating modes respectively. The cylinder pressure gradation of the left Y-axis 9 applies to these curves. Furthermore, the DES valve lift curves 11,11′ the RZV valve lift curves 12,12′ and the NAV valve lift curves 13,13′ are plotted on the cylinder pressure/valve lift diagram 7. The valve lift gradation of the right Y-axis 9′ applies to these curves. On comparing the valve lift curves 11,11′, 12,12′, 13,13′ one notices that the NAV valve lift curves 13,13′ are considerably smaller than the DES valve lift curves 11,11′. The DES valve lift curves 11,11′ also span a larger range of crank angles than the NAV valve lift curves 13,13′. As a result, exhaust gas retention or an internal exhaust gas recirculation is hardly possible with this type of DES valve lift curve 11,11′. In contrast to this, NAV valve lift curves such as 13,13′ allow an internal exhaust gas recirculation and/or an exhaust gas retention to be implemented.

If one now compares the RZV valve lift curves 12,12′ and the NAV valve lift curves 13,13′, one finds that the NAV valve lift curves 13,13′ exhibit a slightly greater valve lift and moreover, they span a wider range of crank angles than the RZV valve lift curves 12,12′. Consequently, such RZV valve lift curves 12,12′ are characterised by a larger exhaust retention or internal exhaust gas recirculation, and allow as a result higher temperatures to be set in the combustion chamber. Due to the small amount of lift and short opening times, however, the air flow is greatly restricted. As a result, such RZV valve lift curves 12,12′ are of only limited use for a high engine load range. This is improved with the illustrated NAV valve lift curves 13,13′, since on the one hand higher valve lifts can be set, and on the other the valve remains open through a wider range of crank angles. Thus using such NAV valve lift curves as 13,13′ allows a lower temperature in the particular combustion chamber to be set, and the intake air volume is greater than with the RZV valve lift curves 12,12′ illustrated in FIG. 2.

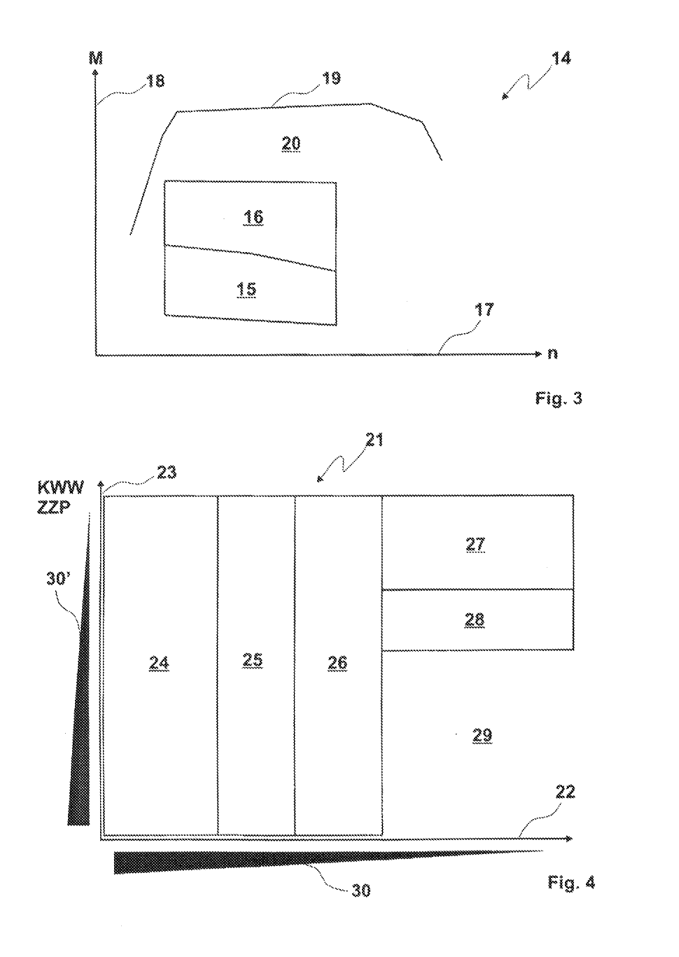

FIG. 3 shows an engine load/engine speed diagram 14, in which an engine characteristics map 15 for the RZV partial operating mode and an engine characteristics map 16 for the NAV partial operating mode are plotted. In the engine load/engine speed diagram 14, the engine speed n is plotted along the X-axis 17 while the engine load M is plotted up the Y-axis 18. A boundary curve 19 delimits the engine load and engine speed range within which the internal combustion engine can be operated. In the engine load/engine speed range 20, which is not encompassed by the engine characteristics map 15 of the RZV partial operating mode or by the engine characteristics map 16 of the NAV partial operating mode, an otto-cycle partial operating mode can be implemented.

A setting conditions diagram 21 shown in FIG. 4 schematically illustrates setting conditions for the RZV partial operating mode and for the NAV partial operating mode. The charge dilution is plotted along an X-axis 22, that decreases in the direction of the X-axis 22 as illustrated by a tapered bar 30. Correspondingly, the engine load increases along the X-axis 22. The crank angle (CA) at the ignition point (ZZP) is plotted up a Y-axis 23, said crank angle likewise decreasing in the direction of Y-axis 23 as illustrated by a tapered bar 30′. The operating ranges 24, 25, 26, 27, 28, 29 are mapped in the settings condition diagram 21. The operating range 24 indicates a possible operating range for the RZV partial operating mode. In this very high charge dilution range it is not possible to spark ignite the correspondingly dilute fuel/exhaust gas/air mixture with an ignition device. The RZV partial operating mode can be advantageously implemented in said operating range 24. With decreasing charge dilution, both the RZV partial operating mode as well as the NAV partial operating mode can be advantageously implemented in operating range 25. By using the NAV partial operating mode, the crank angle at the centre of combustion can be shifted to occur at an earlier crank angle by means of the ignition timing.

If one further lowers the charge dilution, one enters the operating range 26. While it is possible to implement the RZV partial operating mode in operating range 26, in this charge dilution range, the RZV partial operating mode exhibits an increased knocking tendency and is characterised by a correspondingly large increase in pressure. For this reason, in this charge dilution range the RZV partial operating mode suffers from increased operating instability that can be mitigated, for instance, through an external exhaust gas recirculation. This operating range 26 can be bypassed by the NAV partial operating mode, whereby the centre of combustion can in this case likewise be shifted to occur at a lower crank angle by the appropriate choice of ignition timing (ZZP).

The NAV partial operating mode is preferentially implemented in the operating range 27. An otto-cycle partial operating mode can be implemented in the operating range 28. It is usually not possible to implement the RZV, NAV or DES partial operating modes in the operating range 29.

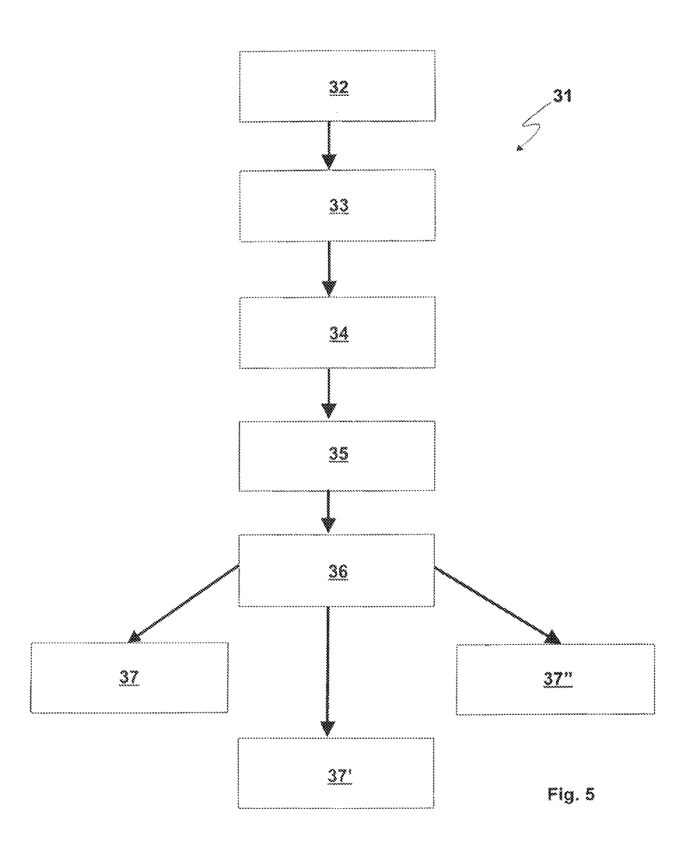

FIG. 5 shows a possible operating strategy diagram 31 that depicts the operating strategy at a lower and middle and possibly high load range of the internal combustion engine. Within these load regions it is alternated between a RZV partial operating mode and a NAV partial operating mode.

In the process a load request 32 originated by the driver is detected. In taking into account the torque request 32, a determination 33 is made regarding the most appropriate partial operating mode to implement. At a middle to low load range it is selected between the RZV partial operating mode and the NAV partial operating mode.

Here it is advantageous to shift between the valve lift curves 11,11′, 12, 12′, 13,13′, since the valve lift curves 11,11′, 12, 12′, 13,13′ of the NAV partial operating mode and the RZV partial operating mode exhibit different progressions. This makes it possible to prevent the RZV partial operating mode being implemented in an engine speed or engine load range in which the RZV partial operating mode can only be implemented with higher operational instability. In this way it is possible to implement homogeneous charge compression ignition, even higher charge dilutions, without the detrimental increase in knocking tendency and the marked increase in pressure caused by the lower charge dilution.

Now that the respective partial operating mode is selected by means of determination 33, a fuel quantity determination 34 is performed based on the selected partial operating mode. When the respective fuel quantity has been established, a charge dilution determination 35 is performed taking into account the established fuel quantity. In addition to this, the required specific heat quantity is calculated based on the established fuel quantity, and translated into the corresponding charge dilution. Now that the charge dilution has been determined, an exhaust gas/air quantity determination 36 is performed and the exhaust gas/air quantity appropriate for the pre-determined fuel quantity determined. The ratio of exhaust gas to air or fresh air can be determined and set here too.

At this point, it can also be decided whether, and to what extent an internal exhaust gas recirculation and/or an external exhaust gas recirculation is performed.

Now that the respective fuel quantity and matching exhaust gas/air quantity has been determined, a valve lift curve selection 37, a turbocharger boost level selection 37′ and a cam position selection 37″ is carried out. The camshaft position selection 37″ enables the volume of recirculated exhaust gas to be specified.

Such an operating strategy enables the preferred operating mode with respect to emissions, fuel consumption and mechanical load to be selected and switched between with the help of at least two partial operating mode (RZV, NAV) in an expanded region of an engine characteristics map concerning engine load and engine speed. In addition and/or alternatively, the DES combustion process can be selected in place of the low NOx controlled auto-ignition (RZV) mode. All of these combustion processes are characterised by improved efficiency in terms of fuel consumption when compared to otto-cycle, homogeneous λ=1 operation.

The compression ratio of the internal combustion engine must be advantageously calculated in order to further improve operation of the internal combustion engine. In particular, the NAV partial operating mode is implemented with a compression ratio of between 10 and 13.

The compression ratio ε is the quotient of the compression volume of the combustion chamber when the piston is at its top dead centre position and the sum of the compression volume and the swept volume of the combustion chamber when the piston is at its bottom dead centre position.

When switching from the RZV partial operating mode to the NAV partial operating mode, the compression ratio c is lowered. As a result of the lower compression ratio ε, the knocking tendency is significantly reduced, and an earlier centre of combustion, as well as a resultant increase in operational stability for the NAV partial operating mode, is effected.

When switching from the NAV partial operating mode to the RZV partial operating mode, the compression ratio ε is raised.

1. Operating mode for an, in particular direct-injection, internal combustion engine with exhaust gas recirculation, in particular for a direct injection gasoline engine, comprising:
wherein a RZV partial operating mode is implemented in a region of the engine characteristics map having low to medium speed and/or low to medium load, said RZV partial operating mode having a lean fuel/exhaust gas/air mixture that is ignited by compression ignition and combusts by controlled auto-ignition (RZV),
wherein the region of the engine characteristics map with compression ignition is bordered at higher load by another region of the engine characteristics map in which low-NOx combustion (NAV) is performed,
wherein at an ignition point (ZZP) a homogeneous, lean fuel/exhaust gas/air mixture with combustion air ratio of λ≧1 in a given combustion chamber of the internal combustion engine is spark ignited by means of an ignition device, and
wherein a flame front combustion (FFV) initiated by the spark ignition transitions to controlled auto-ignition (RZV), wherein it is switched between the RZV partial operating mode having pure controlled auto-ignition (RZV), and the NAV partial operating mode and vice versa, and wherein during a switch between the NAV partial operating mode and the HCCI partial operating mode or vice versa a particular charge dilution range is deliberately skipped.

2. Operating mode according to claim 1, wherein a switch between the NAV partial operating mode and the RZV partial operating mode is performed at an engine speed of between 5% and 70% of the internal combustion engine's maximum engine speed and/or at an engine load of between 5% and 30% of the internal combustion engine's maximum engine load.

3. Operating mode according to claim 1, wherein the RZV partial operating mode is at least temporarily supplanted by a stratified direct injection combustion (DES), so that the DES partial operating mode is implemented instead of the RZV partial operating mode.

4. Operating mode according to claim 1, wherein a torque request from the user is determined, and the respective partial operating mode is selected depending on an engine speed or engine load, said engine speed or engine load being inferred from the torque request given by the user.

5. Operating mode according to claim 1, wherein a fuel quantity to be injected into the respective combustion chamber, possibly by several injections, is determined.

6. Operating mode according to claim 1, wherein a specific heat quantity and/or a charge dilution of the fuel/exhaust gas/air mixture to be burned in the respective combustion chamber is determined.

7. Operating mode according to claim 1, wherein a quantity of fluid and/or gas, comprising exhaust gas and fresh air, to be fed into or retained in the respective combustion chamber is calculated in order to adjust the fuel/exhaust gas/air mixture.

8. Operating mode according to claim 1, wherein a ratio of fresh air and exhaust gas to be set in the fuel/exhaust gas/air mixture is determined.

9. Operating mode according to claim 1, wherein a camshaft position and/or lift curve slope and/or a turbocharger boost level is selected.

10. Operating mode according to claim 1, wherein an internal exhaust gas recirculation and/or an external exhaust gas recirculation is performed.

11. Operating mode according to claim 1, wherein the mode of operation, comprising the NAV partial operating mode and the RZV partial operating mode, is implemented at an engine speed of between 5% and 70% of the internal combustion engine's maximum engine speed and/or at an engine load of between 2% and 70% of the internal combustion engine's maximum engine load.

12. Operating mode according to claim 1, wherein when switching from the RZV partial operating mode to the NAV partial operating mode, a compression ratio ε is lowered, and when switching from the NAV partial operating mode to the RZV partial operating mode, the compression ratio ε is raised.
